(19) United States
(12) Patent Application Publication
(10) Pub. No.: US 2010/0328332 A1
(43) Pub. Date: Dec. 30, 2010

(54) System and method for reducing memory access bandwidth in video decoding

(75) Inventor: Chianwen Chen, Taipei City (TW)

Correspondence Address: BACON & THOMAS, PLLC, 625 SLATERS LANE, FOURTH FLOOR, ALEXANDRIA, VA, 22314-1176, US

(73) Assignee: Sunplus Technology Co., Ltd., Hsinchu (TW)

(21) Appl. No.: 12/801,613

(22) Filed: Jun. 17, 2010

(30) Foreign Application Priority Data
Jun. 30, 2009 (TW) 098121989

(51) Int. Cl. H04N 7/50; H04N 7/26; G06T 9/00

(52) U.S. Cl. 345/555; 375/240.25; 375/240.02; 375/E07.211; 375/E07.027

(57) ABSTRACT

A system for reducing memory access bandwidth in video decoding includes a video decoder, a storage device and a compressor. The video decoder receives a compressed video bitstream and decodes the bitstream to generate decoded I, P and B frames. The storage device has first and second storage areas and is connected to the video decoder. The compressor is connected to the video decoder and the storage device and performs a compression operation on the decoded I, P and B frames to generate compressed decoded I, P and B frames respectively. The decoded I frames and the decoded P frames are stored in the first storage area, and the compressed decoded I frames, the compressed decoded P frames and the compressed decoded B frames are stored in the second storage area.

### BACKGROUND OF THE INVENTION

1. Field of the Invention

The present invention relates to the technical field of memory accesses and, more particularly, to a system and method for reducing memory access bandwidth in video decoding.

2. Description of Related Art

Digital images require a lot of storage and data transmission bandwidths, and thus a video system usually makes use of different compression methods to reduce the required storage and data transmission bandwidths for digital video data, in which the intra-frame compression method is typically used for a still picture or single frame, and the inter-frame compression method is typically used for multiple frames.

Generally, the intra-frame and the inter-frame compression methods convert a video data into frequency domain by, for example, a discrete cosine transformation (DCT), to thereby remove the redundant video data in frequency domain. For encoding/decoding, the two compression methods need a lot of memory to temporarily store the video data. FIG. 1 is a block diagram of a typical video decoder. As shown in FIG. 1, a decoder 110 decodes a compressed video bitstream to generate I, P and B frames. The I frame is an intra-frame obtained by an intra-frame encoding, and decoded without referring to the other frames, but can be a reference to the other frames. The P frame is a predicted frame obtained by an inter-frame encoding, and decoded by referring to the previous I or P frame. The B frame is a bi-predicted frame, and decoded by referring to the previous and following frames. FIG. 2 is a schematic diagram of decoded I, P and B frames displayed in a typical timing. As shown in FIG. 2, the decoded I, P and B frames are stored in a DRAM 120, and a display engine 130 reads the corresponding frames in the DRAM 120 for display.

With the aforementioned structure, at the time of I frame decoding, the decoder 110 writes the decoded I frame into the DRAM 120, and the display engine 130 reads a B frame from the DRAM 120 for a display, so as to perform two frame accesses to the DRAM 120. At the time of P frame decoding, the decoder 110 reads an I or P frame from the DRAM 120 for decoding and writes the decoded P frame into the DRAM 120, and the display engine 130 reads another B frame from the DRAM 120 for display, so as to perform three frame accesses to the DRAM 120. At the time of B frame decoding, the decoder 110 reads an I frame and a P frame respectively from the DRAM 120 for decoding a B frame and writes the decoded B frame into the DRAM 120, and the display engine 130 reads the I or P frame from the DRAM 120 for a display, so as to perform four frame accesses to the DRAM 120.

During the design of an access system for the DRAM 120, i.e., a DRAM controller, the maximum access bandwidth has to be considered. If a frame access to the DRAM 120 requires 2 Mbytes/sec, the DRAM 120 requires at least an access rate of 8 Mbytes/sec to thereby meet the requirement of decoding a B frame. Therefore, increasing the operating frequency of the entire system is limited. Accordingly, it is desirable to provide an improved system and method to mitigate and/or obviate the aforementioned problems.

### SUMMARY OF THE INVENTION

The object of the present invention is to provide a system and method for reducing a memory access bandwidth in video decoding, which uses a compressor to compress a frame generated by a video decoder or a scaling engine to scale the frame generated by the video decoder, thereby reducing the data amount of accessing to a DRAM.

According to a feature of the invention, a system for reducing memory access bandwidth in video decoding is provided. The system includes a video decoder, a storage device and a compressor. The video decoder receives a compressed video bitstream and decodes the bitstream to thereby generate decoded I, P and B frames. The storage device with a first storage area and a second storage area is connected to the video decoder in order to temporarily store data for use in decoding by the video decoder. The compressor is connected to the video decoder and the storage device in order to perform a compression on the decoded I, P and B frames to thereby generate compressed decoded I, P and B frames respectively. The decoded I frame and the decoded P frame are stored in the first storage area, and the compressed decoded I frame, the compressed decoded P frame and the compressed decoded B frame are stored in the second storage area.

According to another feature of the invention, a method for reducing memory access bandwidth in video decoding is provided, which compresses decoded frames to thereby reduce the memory access bandwidth. The method includes: a decoding step to decode a compressed video bitstream and generate decoded I, P and B frames; a first storing step to temporarily store the decoded I frame and the decoded P frame in a first storage area for use in decoding by the video decoder; a compressing step to perform a compression on the decoded I, P and B frames outputted in the decoding step and generate compressed decoded I, P and B frames respectively; and a second storing step to temporarily store the compressed decoded I frame, the compressed decoded P frame and the compressed decoded B frame in a second storage area.

According to a further feature of the invention, a system for reducing memory access bandwidth in video decoding is provided. The system includes a video decoder, a storage device and a scaling engine. The video decoder decodes a compressed video bitstream to thereby generate decoded I, P and B frames. The storage device with a first storage area and a second storage area is connected to the video decoder in order to temporarily store data for use in decoding by the video decoder. The scaling engine is connected to the video decoder and the storage device in order to perform a scaling operation on the decoded I, P and B frames to thereby generate scaled decoded I, P and B frames respectively. The decoded I frame and the decoded P frame are stored in the first storage area, and the scaled decoded I frame, the scaled decoded P frame and the scaled decoded B frame are stored in the second storage area.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a typical video decoder;

FIG. 2 is a schematic diagram of decoded I, P and B frames displayed in a typical timing;

FIG. 3 is a block diagram of a system for reducing memory access bandwidth in video decoding according to an embodiment of the invention;

FIG. 4 is a comparison of memory accesses between the invention and the prior art on video decoding;

FIG. 5 is a block diagram of a system for reducing memory access bandwidth in video decoding according to another embodiment of the invention;

FIG. 6 is a block diagram of a system for reducing memory access bandwidth in video decoding according to a further embodiment of the invention;

FIG. 7 is a block diagram of a system for reducing a memory access bandwidth in video decoding according to another further embodiment of the invention; and

FIG. 8 is a flowchart of a method for reducing a memory access bandwidth in video decoding according to an embodiment of the invention.

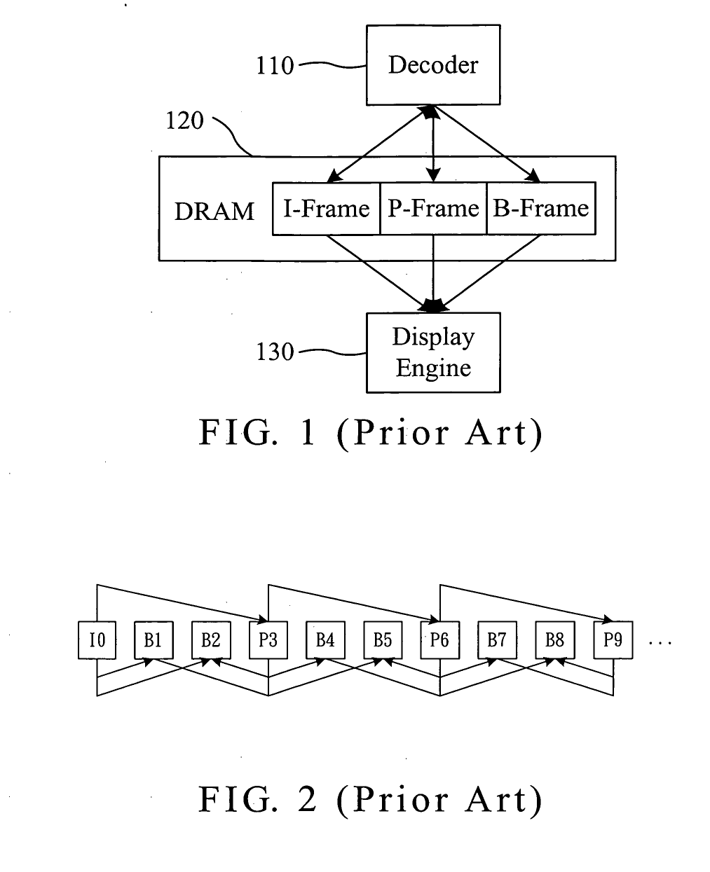

### DETAILED DESCRIPTION OF THE PREFERRED EMBODIMENT

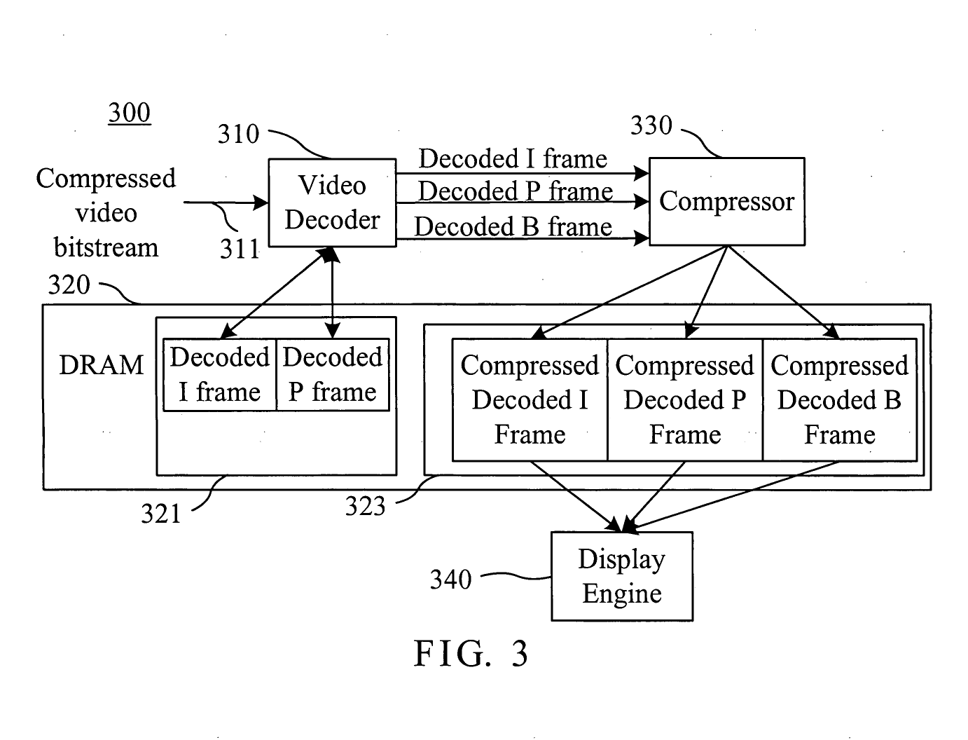

FIG. 3 is a block diagram of a system 300 for reducing memory access bandwidth in video decoding according to an embodiment of the invention. In FIG. 3, the system 300 includes a video decoder 310, a storage device 320, a compressor 330 and a display engine 340.

The video decoder 310 decodes a compressed video bitstream to thereby generate decoded I frames, decoded P frames and decoded B frames. The compressed video bitstream can be stored in the storage device 320 temporarily or inputted to the video decoder 310 through an input pin 311. The compressed video bitstream can be one of MPEG1, MPEG2, MPEG4 and H.263 formats.

The storage device 320 contains a first storage area 321 and a second storage area 323. The storage device 320 is connected to the video decoder 310 in order to temporarily store data for using in decoding by the video decoder 310. The storage device 320 can be an embedded SRAM or DRAM. A decoded I frame and a decoded P frame generated by the video decoder 310 are stored in the first storage area 321.

The compressor 330 is connected to the video decoder 310 and the storage device 320 and performs a compression on the decoded I, P and B frames outputted by the video decoder 310 to thereby generate compressed decoded I, P and B frames respectively. The compressor 330 performs a lossy compression to thereby gain a compression ratio of 50%. Thus, the compressed decoded I frame, the compressed decoded P frame and the compressed decoded B frame have a half size of the decoded I frame, the decoded P frame and the decoded B frame respectively. The decoded I frame and the decoded P frame are temporarily stored in the first storage area 321, and the compressed decoded I frame, the compressed decoded P frame and the compressed decoded B frame are temporarily stored in the second storage area 323.

The display engine 340 is connected to the storage device 320 in order to read the compressed decoded I, P and B frames respectively from the second storage area 323 for display.

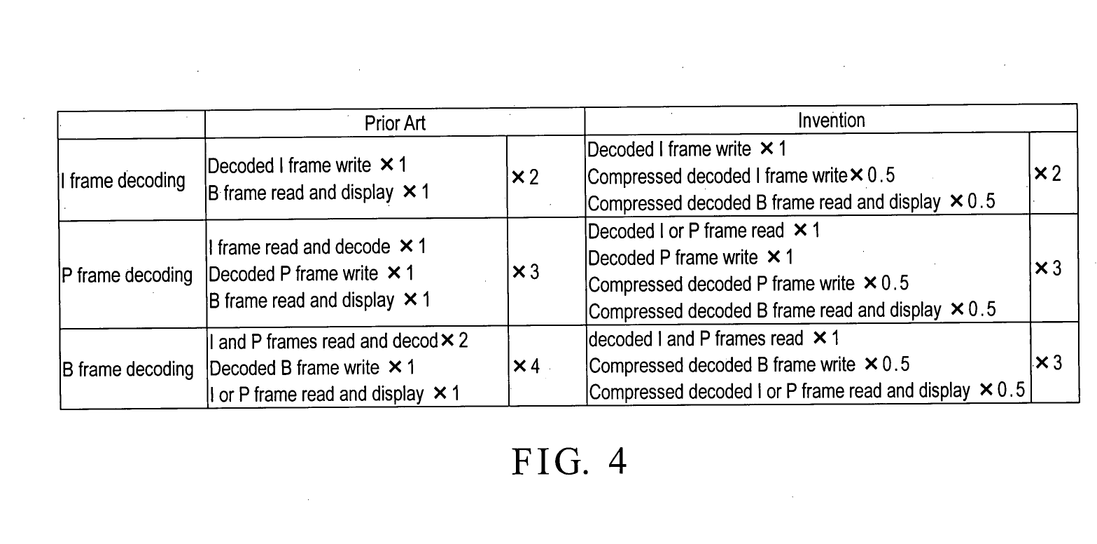

FIG. 4 is a comparison of memory accesses between the invention and the prior art in video decoding.

At the time of I frame decoding, the prior art writes a decoded I frame into the DRAM 120, and uses the display engine 130 to read a B frame from the DRAM 120 for display, so there are two frame accesses to the DRAM 120. By contrast, the invention writes the decoded I frame into the first storage area 321 of the DRAM 320 and the compressed decoded I frame into the second storage area 323 of the DRAM 320, and uses the display engine 340 to read a compressed decoded B frame from the DRAM 320 for display, so there are two frame accesses to the DRAM 320.

At the time of P frame decoding, the prior art reads an I or P frame from the DRAM 120 for decoding, writes the decoded P frame into the DRAM 120, and uses the display engine 130 to read another B frame from the DRAM 120 for a display, so there are three frame accesses to the DRAM 120. By contrast, the invention reads a decoded I or P frame for decoding, writes the decoded P frame into the first storage area 321 of the DRAM 320 and the compressed decoded P frame into the second storage area 323 of the DRAM 320, and uses the display engine 340 to read a compressed decoded B frame from the DRAM 320 for display, so there are three frame accesses to the DRAM 320.

At the time of B frame decoding, the prior art reads an I frame and a P frame respectively from the DRAM 120 for decoding a B frame, writes the decoded B frame into the DRAM 120, and uses the display engine 130 to read the I or P frame from the DRAM 120 for display, so there are four frame accesses to the DRAM 120. By contrast, the invention reads a decoded I frame and a decoded P frame for decoding a B frame, writes the compressed decoded B frame into the second storage area 323 of the DRAM 320, and uses the display engine 340 to read the compressed decoded I or P frame from the DRAM 320 for display, so there are three frame accesses to the DRAM 320.

From the comparison of FIG. 4, it is known that the data amount required for accessing to the DRAM 320 can be effectively reduced 25% in decoding the B frame. For example, 316 Mbytes/sec is reduced to 237 Mbytes/sec. Also, it is shown in FIG. 2 that the B frame decoding occupies a half in video decoding. Accordingly, the data amount required for accessing to the DRAM 320 can be effectively reduced.

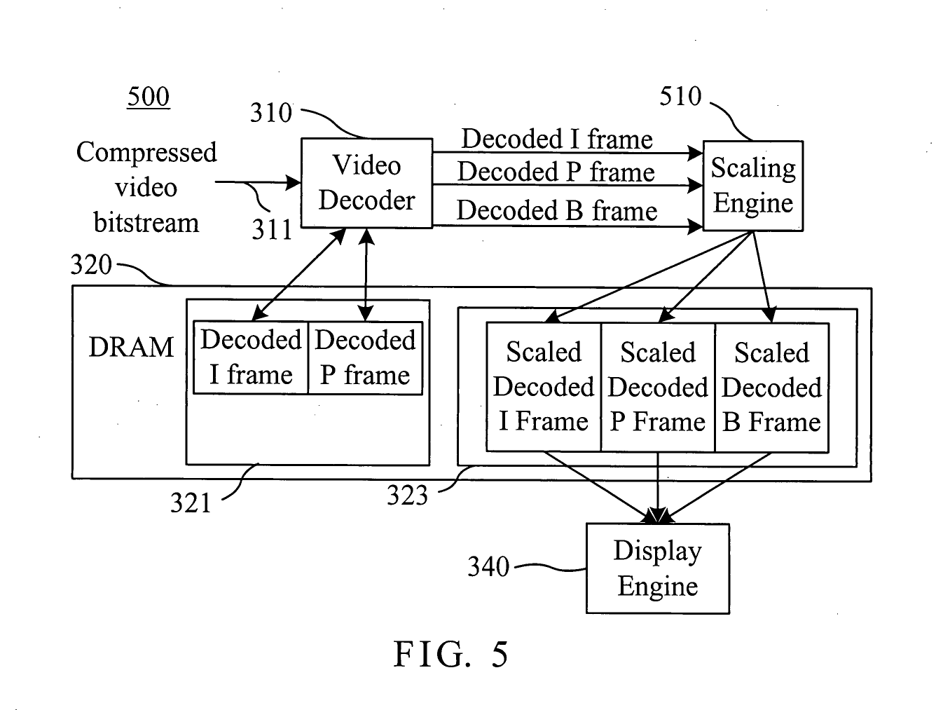

FIG. 5 is a block diagram of a system 500 for reducing memory access bandwidth in video decoding according to another embodiment of the invention, which is similar to the previous embodiment as shown in FIG. 3 except that the compressor 330 in FIG. 3 is replaced with a scaling engine 510 in FIG. 5. The scaling engine 510 is connected to the video decoder 310 and the DRAM 320 in order to perform a scaling operation on a decoded I frame, a decoded P frame and a decoded B frame outputted by the video decoder 310 to thereby generate a scaled decoded I frame, a scaled decoded P frame and a scaled decoded B frame respectively and output the scaled frames to the DRAM 320 for storing. Thus, the data amount required for accessing to the DRAM 320 can be further reduced.

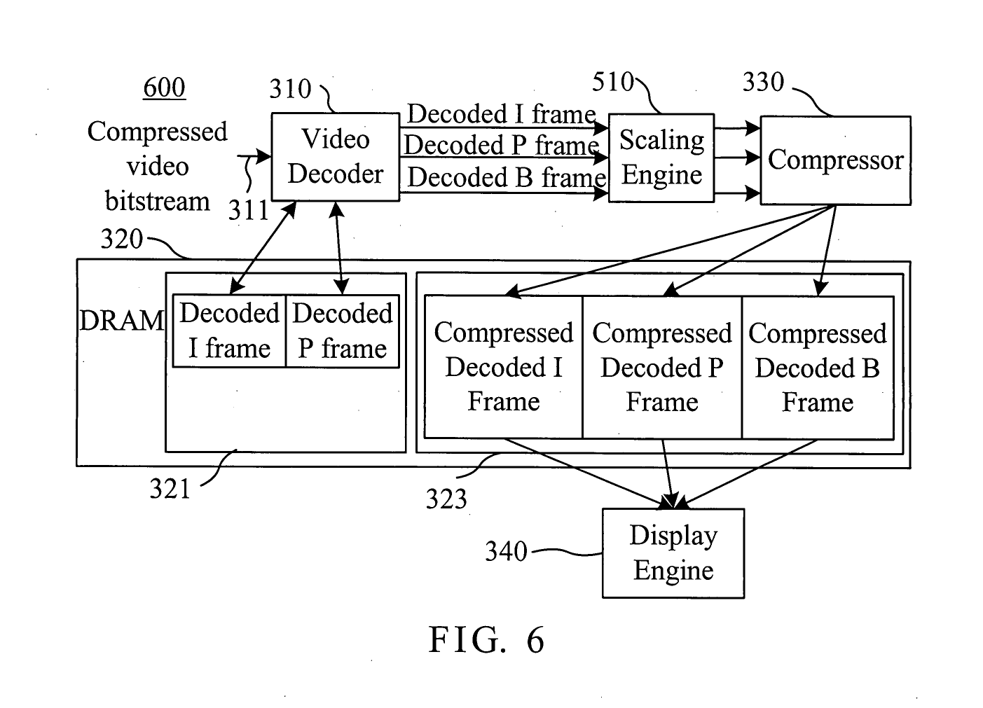

FIG. 6 is a block diagram of a system 600 for reducing memory access bandwidth in video decoding according to a further embodiment of the invention, which is similar to the previous embodiment as shown in FIG. 3 except that a scaling engine 510 is added between the video decoder 310 and the compressor 330 in FIG. 6. The scaling engine 510 connected between the video decoder 310 and the compressor 330 performs a scaling operation on a decoded I frame, a decoded P frame and a decoded B frame outputted by the video decoder 310 and outputs the results to the compressor 330 for a compression. Thus, the data amount required for accessing to the DRAM 320 can be further reduced.

If a compressed video bitstream with a 1920×1080 resolution, 16 bits of pixel and 60 frames/second is decoded, the bandwidth of accessing to the DRAM 120 in the prior art is 1920×1080×16×60×4=949 Mbytes/second for a 640×480 display resolution. However, upon the configuration of FIG. 5 in the invention, the bandwidth of accessing to the DRAM 320 is 1920×1080×16×60×2+640×480×16×60×2=545 Mbytes/second, and in this case 404 Mbytes/second is saved. In addition, upon the configuration of FIG. 6 in the invention and performing a 50% compression, the bandwidth of accessing to the DRAM 320 is 1920×1080×16×60×2+640×480×16×60×2×0.5=510 Mbytes/second, and in this case 439 Mbytes/second is saved.

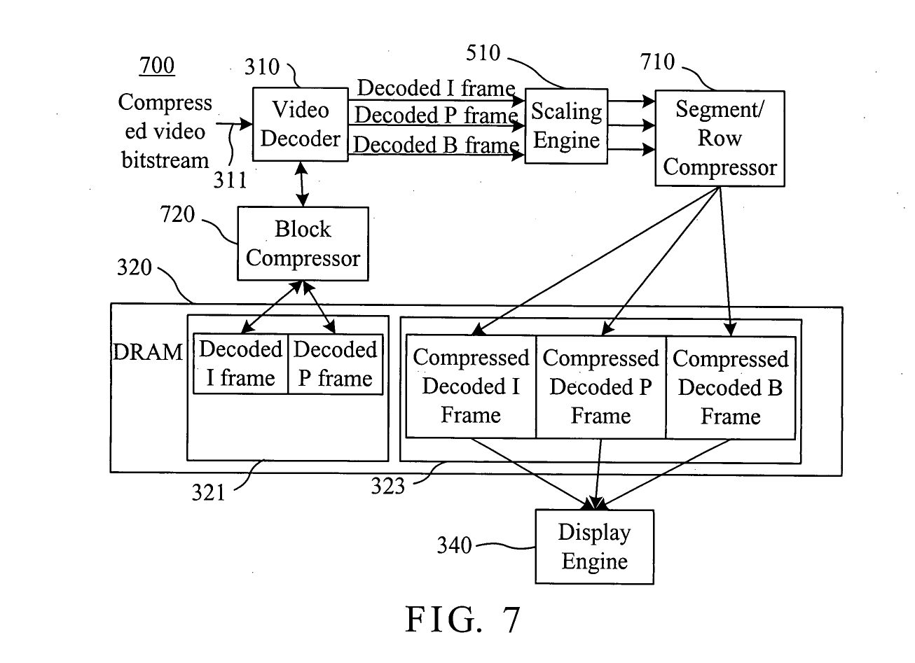

FIG. 7 is a block diagram of a system 700 for reducing memory access bandwidth in video decoding according to another further embodiment of the invention, which is similar to the embodiment as shown in FIG. 6 except that the compressor 330 in FIG. 6 is replaced with a Segment/Row Compressor 710 and a block compressor 720 is added between the video decoder 310 and the DRAM 320 in FIG. 7. The Segment/Row Compressor 710 and the compressor 330 have the same compression function except that the Segment/Row Compressor 710 performs compression in a unit of segment or column of a frame.

The block compressor 720 is connected between the video decoder 310 and the DRAM 320 in order to compress a decoded I frame and a decoded P frame outputted by the video decoder 310 and output the results to the DRAM 320. When the video decoder 310 is to read the decoded I frame and the decoded P frame from the DRAM 320, the block compressor 720 decompresses the decoded I frame and the decoded P frame that are compressed (i.e., the compressed decoded I frame and the compressed decoded P frame) and outputs the same to the DRAM 320. Thus, the data amount required for accessing to the DRAM 320 can be further reduced.

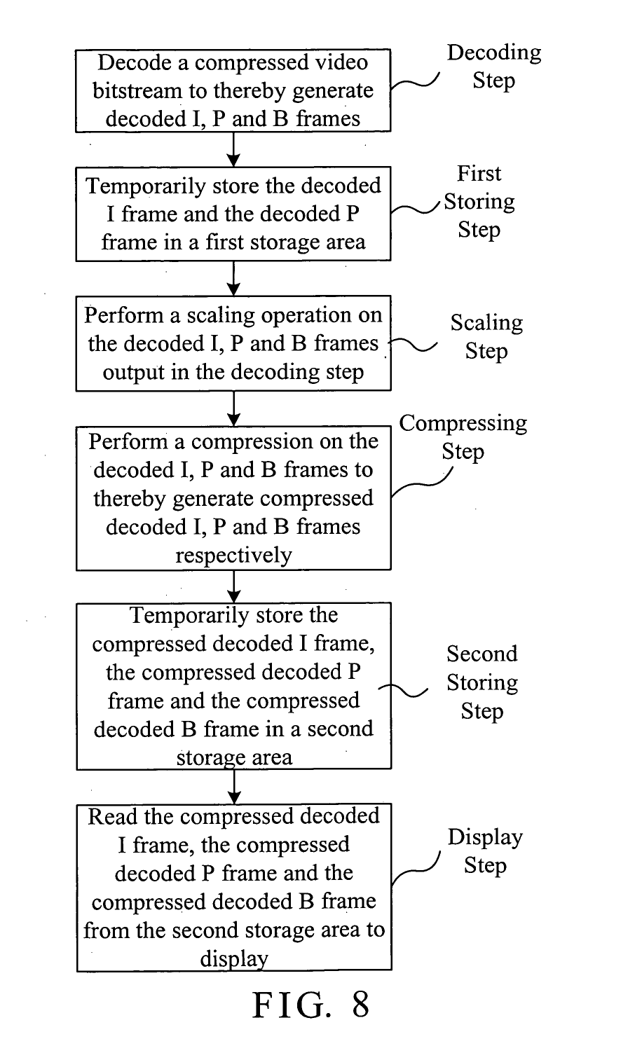

FIG. 8 is a flowchart of a method for reducing memory access bandwidth in video decoding according to an embodiment of the invention. The method compresses the decoded frames to thereby reduce the required memory access bandwidth. As shown in FIG. 8, a decoding step decodes a compressed video bitstream and generates decoded I, P and B frames. The compressed video bitstream can be one of MPEG1, MPEG2, MPEG4 and H.263 formats.

Next, a first storing step temporarily stores the decoded I frame and the decoded P frame in a first storage area for use in decoding by the video decoder.

Next, a scaling step performs a scaling operation on the decoded I frame, the decoded P frame and the decoded B frame outputted in the decoding step.

Next, a compressing step performs a compression on the decoded I, P and B frames outputted in the decoding step and generates compressed decoded I, P and B frames respectively. The compressing step includes a lossy compression.

Next, a second storing step temporarily stores the compressed decoded I frame, the compressed decoded P frame and the compressed decoded B frame in a second storage area.

Finally, a display step reads the compressed decoded I frame, the compressed decoded P frame and the compressed decoded B frame from the second storage area for display.

As cited, the invention stores the decoded I frames and the decoded P frames outputted by the video decoder 310 in the first storage area 321 for use in a P or B frame decoding. The decoded I frames and the decoded P frames stored in the first storage area 321 are not compressed by the compressor 330 or scaled by the scaling engine 510, so the quality of decoding a P or B frame is not affected. In addition, the compressed decoded I frames, the compressed decoded P frames and the compressed decoded B frames outputted by the compressor 330 or the scaled decoded I frames, the scaled decoded P frames and the scaled decoded B frames outputted by the scaling engine 510 are relatively reduced on data amount. Thus, the data amount of accessing to the DRAM 320 is reduced to thereby reduce the memory access bandwidth.

Although the present invention has been explained in relation to its preferred embodiment, it is to be understood that many other possible modifications and variations can be made without departing from the spirit and scope of the invention as hereinafter claimed.

What is claimed is:

1. A system for reducing memory access bandwidth in video decoding, comprising:
a video decoder for decoding a compressed video bitstream to generate a decoded I frame, a decoded P frame and a decoded B frame;
a storage device having a first storage area and a second storage area and connected to the video decoder for temporarily storing data for use in decoding by the video decoder; and
a compressor connected to the video decoder and the storage device for performing a compression on the decoded I frame, the decoded P frame and the decoded B frame to generate a compressed decoded I frame, a compressed decoded P frame and a compressed decoded B frame respectively;
wherein the decoded I frame and the decoded P frame are stored in the first storage area, and the compressed decoded I frame, the compressed decoded P frame and the compressed decoded B frame are stored in the second storage area.

2. The system as claimed in claim 1, further comprising a display engine connected to the storage device for reading the compressed decoded I frame, the compressed decoded P frame and the compressed decoded B frame from the second storage area for display.

3. The system as claimed in claim 2, further comprising a scaling engine connected between the video decoder and the compressor for performing a scaling operation on the decoded I frame, the decoded P frame and the decoded B frame outputted by the video decoder for outputting to the compressor for a compression.

4. The system as claimed in claim 3, wherein the compressor performs a lossy compression.

5. The system as claimed in claim 4, wherein the compressed video bitstream is one of MPEG1, MPEG2, MPEG4 and H.263 formats.

6. The system as claimed in claim 5, wherein the storage device is an embedded SRAM or DRAM.

7. A method for reducing memory access bandwidth in video decoding, which compresses decoded frames to reduce a memory access bandwidth for a storage device, the method comprising:
a decoding step for decoding a compressed video bitstream to generate a decoded I frame, a decoded P frame and a decoded B frame;
a first storing step for temporarily storing the decoded I frame and the decoded P frame in a first storage area for use in decoding by the video decoder;
a compressing step for performing a compression on the decoded I frame, the decoded P frame and the decoded B frame to generate compressed decoded I frame, the compressed decoded P frame and the compressed decoded B frame respectively; and
a second storing step for temporarily storing the compressed decoded I frame, the compressed decoded P frame and the compressed decoded B frame in a second storage area.

8. The method as claimed in claim 7, further comprising a display step for reading the compressed decoded I frame, the compressed decoded P frame and the compressed decoded B frame from the second storage area to display.

9. The method as claimed in claim 8, further comprising a scaling step for performing a scaling operation on the decoded I frame, the decoded P frame and the decoded B frame before the compressing step.

10. The method as claimed in claim 9, wherein the compressing step performs a lossy compression.

11. The method as claimed in claim 10, wherein the compressed video bitstream is one of MPEG1, MPEG2, MPEG4 and H.263 formats.

12. A system for reducing memory access bandwidth in video decoding, comprising:
a video decoder for decoding a compressed video bitstream to generate a decoded I frame, a decoded P frame and a decoded B frame;
a storage device having a first storage area and a second storage area and connected to the video decoder for temporarily storing data for use in decoding by the video decoder; and
a scaling engine connected between the video decoder and the storage device for performing a scaling operation on the decoded I frame, the decoded P frame and the decoded B frame to generate a scaled decoded I frame, a scaled decoded P frame and a scaled decoded B frame respectively;
wherein the decoded I frame and the decoded P frame are stored in the first storage area, and the scaled decoded I frame, the scaled decoded P frame and the scaled decoded B frame are stored in the second storage area.

13. The system as claimed in claim 12, further comprising a display engine connected to the storage device for reading the scaled decoded I frame, the scaled decoded P frame and the scaled decoded B frame from the second storage area for display.

14. The system as claimed in claim 13, further comprising a block compressor connected between the video decoder and the storage device for performing a compression on the decoded I frame and the decoded P frame outputted by the video decoder for output to the storage device, the block compressor performing a decompression on the decoded I frame and the decoded P frame that are compressed, when the video decoder is to read the decoded I frame and the decoded P frame from the storage device.

15. The system as claimed in claim 14, further comprising a Segment/Row Compressor connected between the storage device and the scaling engine for performing a compression on the scaled decoded I frame, the scaled decoded P frame and the scaled decoded B frame outputted by the scaling engine and temporarily storing the frames in the second storage area after the compression.

16. The system as claimed in claim 15, wherein the compressed video bitstream is one of MPEG1, MPEG2, MPEG4 and H.263 formats.

17. The system as claimed in claim 16, wherein the storage device is an embedded SRAM or DRAM.
